(19) United States
(12) Patent Application Publication
(10) Pub. No.: US 2025/0273010 A1
(43) Pub. Date: Aug. 28, 2025

(54) PERCEPTION DETERMINATION USING A SECURE DOMAIN

(71) Applicant: Apple Inc., Cupertino, CA (US)

(72) Inventors: Joachim S. STAHL, Sammamish, WA (US); Daniel C. KLINGLER, San Jose, CA (US); Jozef B. KRUGER, San Diego, CA (US); Richard P. MUFFOLETTO, Bainbridge Island, WA (US); Stephen A. BERARDI, Seattle, WA (US)

(21) Appl. No.: 19/066,017

(22) Filed: Feb. 27, 2025

Related U.S. Application Data
(60) Provisional application No. 63/559,168, filed on Feb. 28, 2024.

(51) Int. Cl. G06V 40/16; G06T 7/70; G10L 17/00

(52) U.S. Cl. CPC G06V 40/161; G06T 7/70; G10L 17/00; G06T 2207/20132; G06T 2207/30201; G06V 2201/07

(57) ABSTRACT

Aspects of the subject technology provide for, processing by a secure system process at a device, captured video data and captured audio data, and determining whether a user is attempting to interact with the device. The data related to the captured video and audio data can be provided to an application process that interacts with the secure system process to determine identity information for the video data and audio data, and frame position data for the people detected in the video data. The system can utilize the video data and the audio data together to determine who in the frame was speaking and if they were directing their speech toward the device.

### CROSS REFERENCE TO RELATED APPLICATIONS

This application claims the benefit of U.S. Provisional Application No. 63/559,168, entitled “PERCEPTION DETERMINATION USING A SECURE DOMAIN,” filed Feb. 28, 2024, the entirety of which is incorporated herein by reference.

### TECHNICAL FIELD

The present description relates generally to electronic devices, including, for example, electronic devices with interactive controls.

### BACKGROUND

Some user devices utilize microphones, cameras, speakers, and display screens, among other sensors and output devices, to receive commands from users and provide responses to users. Security around such features may be important as a matter of public trust and/or a matter of ethical development. For example, if a microphone of a device is “always on,” such as while waiting for a wake word or phrase, the data collected by the microphone should be partitioned in some manner from being accessible to application processes. Native system processes can, for example, collect data and analyze the data in some manner, then notify an application when a set of conditions is detected on the data, such as the detection of a wake word.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of various example electronic devices that may implement aspects of the subject technology in accordance with one or more implementations.

FIG. 2 illustrates data flow in a device used for determining user intended interaction in accordance with one or more implementations.

FIG. 3 illustrates a block diagram of an electronic device for determining user intended interaction in accordance with one or more implementations.

FIG. 4 illustrates a flow diagram of an example process for determining an intended user interaction, in accordance with one or more implementations.

FIG. 5 illustrates a flow diagram of an example process for determining an intended user interaction, in accordance with one or more implementations.

FIG. 6 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

User devices, such as phones, tablets, computers, and music players, can utilize input devices to receive interaction data from users and can utilize output devices to provide information to users in response. In one example, a user device can listen for a wake word or phrase using a microphone that constantly samples its environment. When the wake word or phrase is detected, then the user device can notify an application running thereon that relevant audio is available, and the application can utilize various processes to determine what words were said following the wake word or phrase and respond accordingly. It may be desirable, however, to utilize other sensors or input devices of the user device to obtain additional cues in the environment of the device to perceive an attempted user interaction in other ways.

Aspects of the subject technology may receive streams of input video, audio, and/or other sensor data at a user device and, in a secure system process, determine or perceive that a user in the environment is attempting to interact with the user device. Upon perceiving that the user is attempting to interact with the user device, the subject technology can notify an application process to manage the processing of the data associated with the interaction in a data-privacy protecting manner. The application process can call various system processes to obtain information from the data captured by the various input devices without obtaining the data capture itself. In such a manner, the application can obtain relevant information to provide suitable responses based on the attempted interaction, while protecting the captured data. Because a camera is used which may continuously capture frames of data, the camera images associated with processes described herein are never allowed out of a secured memory area, discussed in greater detail below. Similarly, because a microphone is used in a manner which may continuously capture segments of audio, the audio data associated with the processes described herein are never allowed out of the secured memory area. Other processes of the devices discussed herein may utilized the microphone and camera hardware in a manner that makes clear to the user that the images and/or audio are being accessed by an application. Thus, for the privacy concerns of the users and others in the environment of the devices discussed here, the images and audio is only stored in the secured environment. Moreover, the data associated with these captured images and audio is not stored indefinitely but for short periods of times, e.g., minutes at most and usually only seconds. As such, the user's privacy is protected and preserved.

Other aspects of the subject technology may receive streams of input video, audio, and/or other sensor data at a user device and, in a secure system process, determine or perceive that an aspect of a current user interaction with the device has changed. Upon perceiving that an aspect of the user interaction has changed, the subject technology can notify an application that is currently handling the interaction of the change and the application can provide a suitable response to the change.

The user devices implementing these aspects may include input devices, such as a camera, a microphone, a radar sensor, a thermal sensor, alone or in multiples, or in combination with each other. For example, a camera on the device may obtain a stream of input data from the camera for analysis by a system process. The system process may determine, based on a pose, facial express, hand position, or body position of a person detected in the scene, that the person is intending to interact with the device. The system process may provide some information regarding the captured images without providing any of the captured images to an application process. The application process can request additional information from the system process or another system process which can further analyze the captured images, for example, for facial recognition to determine an identity of the person. The identity may be provided to the application, which can then update an output device of the user device based on the identity information. In some aspects, when multiple people are detected, the system process can use both captured audio data and captured image data to match the audio data with the captured image data to determine which of the multiple people are attempting to interact with the device.

The systems and processes described herein provide an improvement in interacting with a device so that a user of the device can interact with the device in a more conversational, natural manner. The systems and processes described herein utilize a microphone and/or camera and/or other input device in a continuous manner. Privacy concerns associated with this type of activity are addressed through the use of secured areas of processing and data storage so that no captured data is available outside of the secured processing and data storage area. Thus, the systems and processes described herein improve privacy and data security, while also improving device capabilities. The systems and processes described herein also improve upon existing technologies by utilizing face position and audio embeddings to determine if a user is speaking in a manner that indicates an intention to interact with the device.

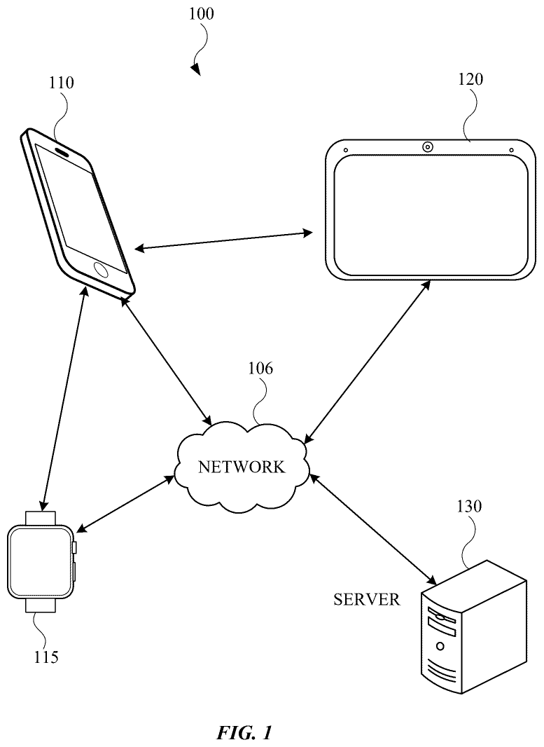

FIG. 1 illustrates an example of an environment in which state information between devices is exchanged in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 120, and a server 130. The network 106 may communicatively (directly or indirectly) couple the electronic device 110 and/or the server 130, the electronic device 115 and/or the server 130, the electronic device 120 and/or the server 130, the electronic device 110 and/or the electronic device 115, the electronic device 110 and/or the electronic device 120, the electronic device 115 and/or the electronic device 120. In one or more implementations, the network 106 may be an interconnected network of devices that may include, or may be communicatively coupled to, the Internet. For explanatory purposes, the network environment 100 is illustrated in FIG. 1 as including an electronic device 110, an electronic device 115, an electronic device 120, and a server 130; however, the network environment 100 may include any number of electronic devices and any number of servers.

The electronic device 110, 115, and/or 120 may be, for example, a desktop computer, a portable computing device (e.g., a laptop computer, a smartphone, etc.), a peripheral device (e.g., a digital camera, headphones), a media player, a tablet device, a wearable device (e.g., a watch, a band, etc.), a computing device (e.g., an embedded computing device), and the like, or any other appropriate device.

In some implementations, the electronic device 110, 115, and/or 120 includes, for example, one or more wireless interfaces, such as WLAN radios, cellular radios, Bluetooth radios, Zigbee radios, near field communication (NFC) radios, and/or other wireless radios.

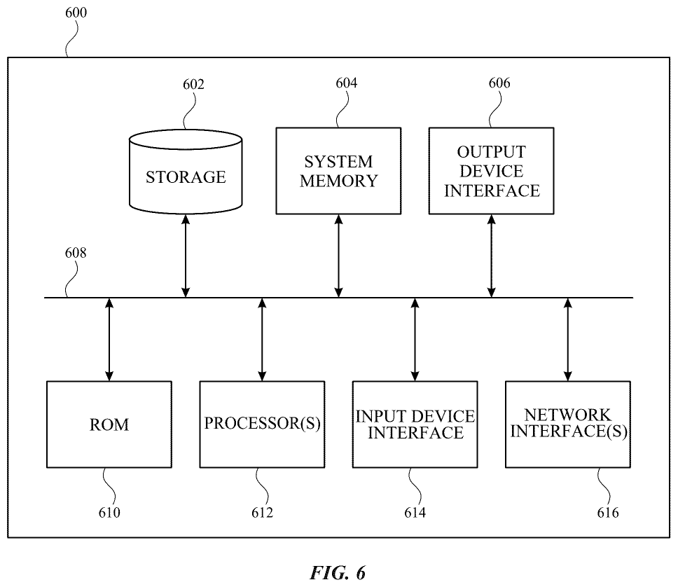

The electronic device 110, 115, and/or 120 may be, and/or may include all or part of, the electronic system discussed herein with respect to FIG. 6. In one or more implementations, the electronic device 110, 115, and/or 120 may include a touchscreen, a camera, a microphone and/or other components. In some implementations, the electronic device 110, 115, and/or 120 may be, for example, a portable computing device (e.g., a laptop computer) that includes a touchscreen, a smartphone that includes a touchscreen, a peripheral device that includes a touchscreen (e.g., a digital camera, headphones), a tablet device that includes a touchscreen, a wearable device that includes a touchscreen (e.g., a watch, a band, etc.), a computing device (e.g., an embedded computing device) that includes a touchscreen, and the like, any other appropriate device that includes, for example, a touchscreen, or any electronic device with a touchpad. The electronic device 110, 115, and/or 120, may further include motion sensors such as gyroscopes, accelerometers, global positioning system (GPS) components, magnetic sensors such as compasses, and the like, and may be, for example, a smart phone or media player device. Additionally, the electronic devices 110, 115, and/or 120 include a respective memory on which data can be stored. In FIG. 1, by way of example, the electronic device 110 is depicted as a smartphone, the electronic device 115 is depicted as a smart watch, and the electronic device 120 is depicted as a laptop computer, media player, or tablet.

In one or more implementations, any of the electronic devices 110, 115, and/or 120 may be configured to provide enhanced user interaction by utilizing the perception techniques discussed herein. For example, as a user interacts with a device, the perception system can determine a change in the user interaction and react accordingly. Or, in another example, the perception system can detect when a user is intending to interact with one of the electronic devices 110, 115, and/or 120 and react accordingly. Implementations, however, provide the ability to detect a user intention to interact with one of the electronic devices 110, 115, and/or 120 without a special wake word or special gesture to determine whether the interaction is occurring.

In one or more implementations, the server 130 may provide a remote data storage for storing data associated with or generated by the electronic device 110, 115, and/or 120. In one or more implementations, one of the electronic devices 110, 115, and/or 120 may be an accessory device and be in communication with one of the other electronic devices 110, 115, and/or 120, such that when an interaction is perceived on one of the electronic devices 110, 115, and/or 120, an appropriate response can be provided on another one of the electronic devices 110, 115, and/or 120. It should be appreciated that the electronic device 110, the electronic device 115, the electronic device 120, and/or server 130 can access and exchange data stored on other devices and/or servers directly (e.g., without network 106) using wireless signals such as near-field communications (NFC), Bluetooth signals, direct WiFi signals, and/or wired connections.

For the sake of simplicity, actions described below are done so in the context of being performed on the electronic device 110; it should be understood, however, that such actions may instead or in addition be performed on the electronic device 115 and/or the electronic device 120.

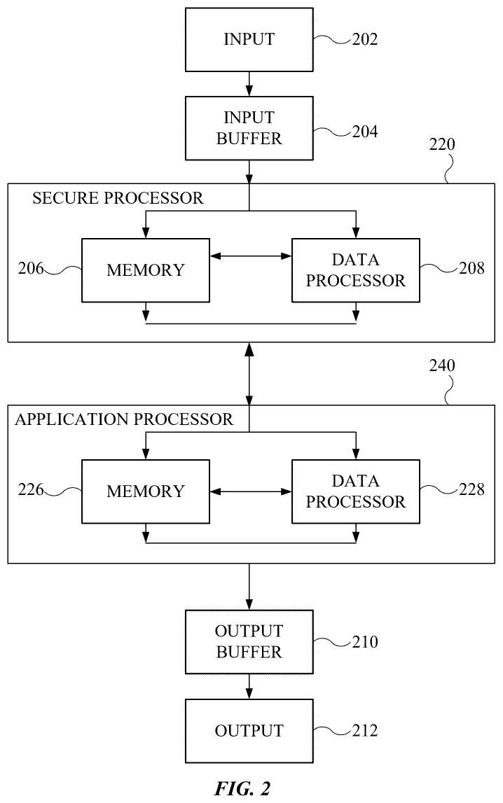

FIG. 2 illustrates data flow in a device used for processing input data in accordance with one or more implementations. Typical processing of data (e.g., at the electronic device 110, 115, and/or 120) begins when the data is received at an input 202 and processed into an input buffer 204. The input data is then transferred to a secure processor 220, where it is processed, and data derived from the input data is provided to an application processor 240. The application processor 240 and secure processor 220 may transfer data back and forth with each other. The application processor 240 may provide output to the output to the output 212 by way of the output buffer 210. In some implementations, the secure processor 220 may provide output to the output 212 by way of the output buffer 210.

The secure processor 220 may include a memory 206 and a data processor 208. Depending on specific implementations, the secure processor 220 may also include other processors such as, for example, a graphics processor (which is not explicitly shown in FIG. 2). Thus, based on the type of device, the data processor 208 may perform, among other things, compression and/or decompression of the received data, encrypt the received data for storage, modulate or demodulate the received data, and/or perform other data manipulation. In a similar manner, the application processor 240 may include a memory 226 and a data processor 228. Depending on specific implementations, the application processor 240 may also include other processors such as, for example, a graphics processor (which is not explicitly shown in FIG. 2). Thus, based on the type of device, the data processor 228 may perform, among other things, compression and/or decompression of the received data, encrypt the received data for storage, modulate or demodulate the received data, and/or perform other data manipulation. The secure processor 220 may therefore be configured to retain certain types of information from being accessible by the application processor 240. Such information can further be encrypted by the secure processor 220 to prevent use of the information as a further safeguard of the information.

In some implementations the secure processor 220 and the application processor 240 may be implemented as two parts, or partitions, of a single processor device. As such, the memory 206 and memory 226 may be part of the same memory device, however, part of the memory may be dedicated for the secure processor 220 and inaccessible by the application processor 240. Similarly, the data processor 208 and the data processor 228 may be part of the same processor device, but may operate independently from one another and may have their own dedicated portions of memory.

In some implementations, each of the electronic devices 110, 115, and 120 and server 130 can include the data flow of FIG. 2. The application processor 240 of one of the electronic devices 110, 115, and 120 may be configured to share data with a corresponding application processor 240 of another one of the electronic devices 110, 115, and 120, however, the data in the secure processor 220 is configured to not be accessible outside of the electronic device 110, 115, and/or 120. The components used to implement the data flow of FIG. 2 may include all or part of the electronic system of FIG. 6.

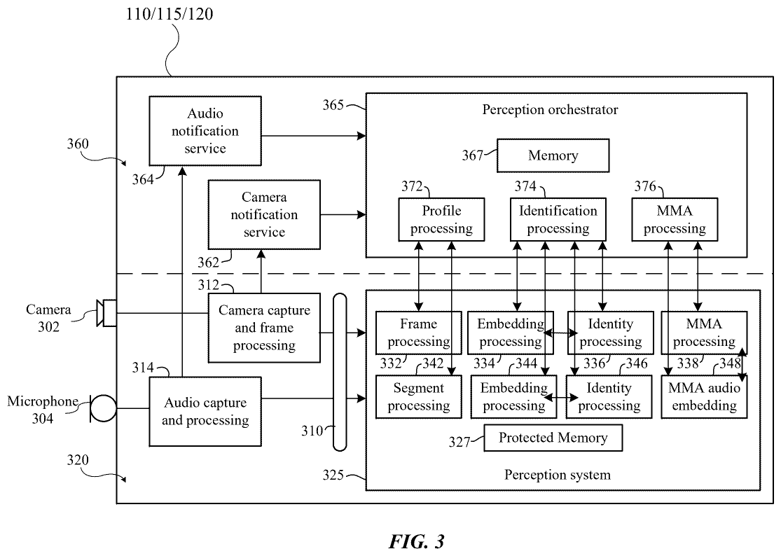

FIG. 3 illustrates a diagram of a perception system for detecting user intention based interactions with a device, in accordance with some implementations. The region below the dashed line is performed in an exclave environment 320, by one or more exclave processes. The region above the dashed line is performed in an application environment 360, by one or more application processes. As used herein an exclave is a portion of a system or application that is performed in a secure area, or domain, of the device. These portions of the application may have access to system resources which are logically and/or physically inaccessible from the application environment. Data passed out of the exclave environment 320 and the application environment 360 can be highly controlled and audited at least because the only way to pass the data out of the exclave is from a process running in the exclave. The exclave environment 320 itself is located in a system portion of the device, but unlike typical system processes, may include application code. For this reason, for the sake of simplicity, a process running in the exclave environment 320 may be referred to as a system process and a process running in the application environment 360 may be referred to as an application process.

As an additional measure of security, in some implementations, the various modules and processes of the perception system 325, discussed below, may only be triggered or instantiated by a corresponding application, such as the perception orchestrator 365.

In implementations described herein, the input devices, such as the camera 302 and the microphone 304 (and other input devices, if available), may provide input into the exclave environment 320. Because the exclave environment 320 is a secure environment which can store data in a secure and privacy protecting manner, the camera 302 and microphone 304 can be sampled continuously at corresponding processes in the exclave environment 320. In particular, the camera capture process 312 can sample the camera 302 input at a particular sample rate, for example, between 1 and 30 frames per second, such as between 4 and 15 frames per second. Then, a frame processing process can analyze each frame one at a time to determine information about the frame and the contents of the captured frame (which can synonymously be referred to as a captured image or captured image or frame data). Similarly, the audio capture process 314 can sample the microphone at a particular sample rate, for example, between about 1 kHz and 44 kHz. Then, an audio processing process can analyze the audio to determine information about the audio and the contents of the captured audio. In some implementations, multiple cameras 302 and/or microphones 304 can be used.

Referring to the input data from the camera 302, the captured frame can be analyzed to determine information about the contents of the captured frame. This information about the contents of the captured frame can be referred to as metadata or additional data. For example, if multiple people are determined to be in the frame, the captured frame can be analyzed to determine body/head/hand/arm/leg position for each of the persons in the frame. The location of each person in the frame and approximate distance from the camera device can be determined for each person in the frame. In addition, an image crop for each face of each person can be made for each frame. A generic identifier can be attributed to each of the person in the frame and the various attributes (such as body, head, or hand position) of that person may be associated with that identifier. For example, the hand position of person 1 may be determined to be a particular hand position in a first frame, and the hand position is associated with person 1. A characterization for each of the attributes for each of the persons can be determined for each frame. Additional information unrelated to people can be determined for the frames. For example, the presence of animals, such as pets, can be detected and determined through analysis of the captured frames.

When activity is detected in the frame, the camera capture process 312 can notify the camera notification service 362. The camera notification service 362 can, in turn, notify the perception orchestrator 365. The perception orchestrator 365 may then instruct the perception system 325 to begin a process to determine if the activity detected in the frame is activity which indicates that a user in the frame is intending to interact with the electronic device 110, 115, and/or 120 or activity which indicates that something about an ongoing interaction with the electronic device 110, 115, and/or 120 has changed. The camera capture process 312 can provide to the exclave perception system 325 all of the information that has been derived from the processing of the captured frames. An exclave system process 310 can be used to pass the processed data from the camera capture process 312 through to the perception system 325. The exclave system process 310, for example, can be configured to provide the face crops and frame metadata to the frame processing 332.

Referring now to the input data from the microphone 304, the captured audio segment can be analyzed to determine information about the contents of the captured segment. This information about the contents of the captured segment can be referred to as metadata or additional data. For example, the audio segment can be analyzed to determine volume, time associated with the captured segment, such as time stamps associated with the beginning of the captured segment, end of the captured segment, and duration of the captured segment. In accordance with some implementations, the audio may include spatial data so that a direction can be determined from where the audio was originating, for example, a direction with respect to the electronic device 110, 115, and 120.

When audio activity is detected in the segment, the audio capture process 314 can notify the audio notification service 364. The audio notification service 364 can, in turn, notify the perception orchestrator 365. The perception orchestrator 365 may then begin a process to determine if the activity detected in the segment is activity which indicates that a sound in the segment, such as a voice, is intending to interact with the electronic device 110, 115, and/or 120 or activity which indicates that something about an ongoing interaction with the electronic device 110, 115, and/or 120 has changed. The audio capture process 314 can also provide to the exclave perception system 325 all of the information that has been derived from the processing of the captured segment. In some implementations, an exclave system process 310 can be used to pass the processed data from the audio capture process 314 through to the perception system 325, while in other implementations, the audio segments may be stored in a shared secure memory as a rolling buffer or circular buffer along with timestamp data for the audio segments. The shared secure memory for the audio segments may be accessible by other exclave processes.

In such a manner, parallel paths through either the camera notification service 362 or audio notification service 364 (or both) may be used to trigger the perception orchestrator 365 to begin processing the video and/or audio information to determine if a user interaction is intended. Triggering the one process (either the camera notification service 362 or the audio notification service 364) may result in action being taken by the perception orchestrator 365 for both audio and video.

Turning now to the perception system 325 in the exclave environment 320 and the perception orchestrator 365 in the application environment 360, various processes in the perception orchestrator 365 can work with processes in the perception system 325 to ultimately determine if a user is attempting to interact with the electronic device 110, 115, and/or 120, and who that user is. Beginning with the frame processing 332, the face crops and additional data related to the captured frame can be provided to the frame processing 332 by the exclave system process 310. As noted above, the face crops can be stored in the protected memory 327, for example, in a face crop buffer. The face crops include a face crop images for the captured frame according to each of the faces detected in the captured frame. In some implementations, only fully visible faces are stored, while in other implementations, partially visible faces are stored or images of the backs of heads may be stored when no face is visible in the frame but the frame processing associated with the camera capture process 312 determines that a head is visible in the captured frame. In some implementations, the exclave system process 310 can provide the frame crops to the frame processing 332 and the frame processing 332 can organize the frame crops into the protected memory 327.

As noted above and here reiterated, the system processes, such as provided for in the exclave environment 320 by the perception system 325, camera capture and frame processing 312, and audio capture and processing 314 effectively only provide descriptions of the captured video and captured audio data outside of the exclave environment 320 and never the actual video or audio data itself.

The frame processing 332 can send the metadata or additional frame information to the profile processing 372 of the perception orchestrator 365, without sending any of the raw pixel data to the profile processing 372, including any of the face crop data. Each of the faces associated with the face crop data can be associated with a placeholder person by frame processing 332. In a subsequent process, an attempted identification can be performed on the frame crops. The profile processing 372 can also maintain a placeholder profile for each of the faces of the face crop data. The profile processing 372 can only associate with the placeholder profile the metadata or additional frame information data with each of the placeholder persons because the profile processing 372 does not have the face crop data. Placeholder identifiers can be generated for the placeholder profiles. The placeholder identifiers can be linked between the profile processing 372 and the frame processing 332 so that if the frame processing 332 provides metadata for person 1, the metadata is attributed to a placeholder profile for the same person 1 in the profile processing 372, and vice versa. When the frame processing 332 sends the metadata or additional frame information to the profile processing 372, the number of persons determined to be in the frame capture can be derived from the metadata or additional frame information. The profile processing 372 can store its data in memory 367. Face crop IDs can be provided from the frame processing 332 to the profile processing 372.

The perception orchestrator 365 can then utilize identification processing 374 to begin an identification process for each of the placeholder profiles set up by the profile processing 372. For each captured frame, the identification processing 374 can request the embedding processing 334 to generate embeddings for each of the faces in the face crops. The embedding processing 334 can generate the embeddings by accessing the face buffer from the protected memory 327 to determine an embedding for each of the faces in the face crops. The embeddings can be created from a face crop for each frame for each person. Any suitable process can be used to create the embeddings. In some implementations, the embeddings can be provided to the identification processing 374 while in other implementations, the embeddings may be considered sensitive data which is not subject to removal from the exclave environment 320, and only a handle to the embedding is provided to the identification processing 374. Following generating the embeddings, the identification processing 374 can request from the perception system 325 to utilize identity processing 336 to attempt to match the embeddings with an embedding from a database of embeddings, for example, using a machine learning model, to determine a known identity corresponding to the embedding. For example, the identification processing 374 may ask the identity processing 336 to determine the identity according to embedding 3. The corresponding embedding for the corresponding face crop in the buffer of face crops may be provided to a database or machine learning model to determine identity information for the corresponding face crops. For example, the identity processing may return a list of possible matches for the embedding plus a confidence level for each possible match. The corpus of identities for matching may correspond to a pool of known possible users, for example, in a household. For example, a low confidence score may indicate that the likelihood that the identified person actually corresponds to the face crop is lower than an identified person with a higher confidence score. In some implementations, the identity which has the highest confidence score which is over a minimum threshold may be selected as being the determined identity corresponding to a particular embedding. This process can be repeated for any number of embeddings determined from the face crops.

In the event that an identity is not found for the embedding in the identity processing 336, a unique unknown identity can be saved into the database, for example, added to the machine learning model and/or an embedding space, as a new embedding. When identity information or partial identity information corresponding to the embedding becomes known at some future time, then the database can be updated to include the known identity information corresponding to the new embedding.

The identity determined from the identity processing 336 may be provided to the identification processing 374 and matched to each of the placeholder person profiles in the perception orchestrator 365. In the case that the identity is an unknown, then the unique unknown identity can be provided to the identification processing 374. The unique unknown identity, for example, can be a serial number identifier or record number identifier unique to the person (e.g., based on and/or derived from the embedding).

Turning back to the audio side of the perception orchestrator 365 and perception system 325, upon notification from the audio notification service 364, the profile processing 372 of the perception orchestrator 365 can request the segment processing 342 to begin processing the audio segments available in the exclave environment 320. The audio segment can be provided to the protected memory 327 (or a similar memory outside of the perception system 325, but within the exclave environment 320) or to the segment processing 342. The audio segment may be provided by the exclave system process 310 or by the audio capture and processing 314. In some implementations, the audio segment can first be analyzed separately and processed by an echo cancellation process to result in an echo-cancelled audio segment. As noted above, the segments can be stored in the protected memory 327, for example, in an audio segment buffer. The segment processing 342 can provide further analysis and processing of the audio segments to extract metadata or additional segment information about the audio segments. In some implementations, the segment processing 342 can analyze the audio segments to determine if speech is present in the audio segment. In some implementations, the segment processing 342 may also determine if there is one speaker or multiple speakers represented in the speech of the audio segment. If speech is present, then in some implementations, the segment processing 342 can use speech machine learning models to determine what the content of the speech is, or in other words, may determine the content of the speech using known processes. In other implementations, the content of the speech need not be determined. In some implementations, if speech is detected, the language of the speech can be determined.

The segment processing 342 can send the metadata or additional segment information to the profile processing 372 of the perception orchestrator 365, without sending any of the raw audio data to the profile processing 372. In a subsequent process, an attempted identification can be performed on the audio segment.

The perception orchestrator 365 can then utilize identification processing 374 to begin an identification process for the audio segments stored in the exclave environment 320. The identification processing 374 can request from the embedding processing 344 to generate an embedding for each audio segment. The embedding processing 344 can generate the embeddings by accessing the audio segment buffer from the protected memory 327 (or from a similar memory outside the perception system 325 but inside the exclave environment 320) to determine an embedding for the audio segments. In some implementations, the process of creating the embeddings can reveal that one or more than one speaker is present. For example, if multiple voices are present, then the process of creating the embeddings can cause clustering for multiple samples for each unique voice depicted in the audio segment. The number of clusters can correspond to each voice in the audio segment and each clustered embedding can be used for attempting an identification of the voice. Any suitable process can be used to create the embeddings. In some implementations, the embeddings can be provided to the identification processing 374 while in other implementations, the embeddings may be considered sensitive data which is not subject to removal from the exclave environment 320 and a handle to each of the embeddings may be provided to the identification processing 374 instead.

The identification processing 374 can then pass the embeddings handles to the identity processing 346 to attempt to match the embeddings with an embedding from a database of embeddings, for example, using voiceprint technology via a machine learning model, to determine one or more known identities corresponding to the embeddings. In particular, each embedding from the audio segment may be provided to a database or machine learning model to determine identity information for each of the embeddings derived from the audio segment. For example, the identity information can include a list of possible matches along with a confidence score for each of the possible matches. The corpus of identities for matching may correspond to a pool of known possible users, for example, in a household. The confidence score may be provided based on how close the embedding is to the embeddings contained in the database or model, for example, based on the Euclidean distance between an embedding and candidate embeddings from the corpus. For example, a low confidence score may indicate that the likelihood that the identified person actually corresponds to the audio segment is lower than an identified person with a higher confidence score. When more than one person is identified in the embeddings, the identity processing 346 can provide each of the identified persons and the corresponding score to the identification processing 374. In some implementations, the identity which has the highest confidence score which is over a minimum threshold may be selected as being the determined identity corresponding to the embedding. This process can be repeated for any number of embeddings determined from the audio segments.

In the event that an identity is not found for the embedding in the identity processing 346, a unique unknown identity can be saved into the database, for example, added to the embedding space and/or via a machine learning model, as a new embedding. When identity information or partial identity information corresponding to the embedding becomes known at some future time, then the database can be updated to include the known identity information corresponding to the embedding.

The identity determined from the identity processing 346 may be provided to the identification processing 374. If the determined identity from the audio segments matches the determined identity from the captured frames, then that association can be made clear in the identification processing. In the case that the identity is an unknown, then the unique unknown identity can be provided to the identification processing 374. The unique unknown identity, for example, can be a serial number identifier or record number identifier unique to the person (based on the embedding).

When the identification processing 374 has determined identification information for both the audio segments and the captured frames, if possible, the identification processing 374 can merge the identification information together to provide identifications for each of the placeholder profiles. For example, each of the identifications for the face crops can be provided to the identification processing 374 and the identification processing 374 can merge or associate each of the identifications to the placeholder profiles for the captured frames. Likewise, each of the identifications for the audio segments can be provided to the identification processing 374 and the identification processing 374 can merge or associate each of the identifications to the audio placeholder profiles for the audio segment. It may be possible to merge or associate one or more of the profiles for the captured frames with the profiles for the audio segments when the identification overlaps. It may be possible, however, that one or both of the identification information is unknown for the placeholder profiles. Even if the identity is discovered, it cannot be known for sure in this process that the user was intending to interact with the device.

The perception orchestrator 365 may use multi-modal attention (MMA) processing 376 to determine which face crops are associated with the audio segment and whether a user had intended to interact with the electronic device 110, 115, and/or 120. The MMA processing 376 does not have access to the face crops but can utilize the face crop identifiers described above to instruct the MMA processing 338. It should be appreciated that the MMA processing 376 may occur at the same time as the identification processing 374 or before the identification processing, in some implementations. The MMA processing 376 coordinates with a corresponding MMA processing 338 of the perception system 325. The MMA processing 376 requests the MMA processing 338 to run MMA for each face crop by the face crop identifier. The MMA processing 376 requests the MMA audio embedding 348 to obtain the embeddings. The MMA processing 338 compares each of the face crops to the MMA audio embeddings to determine if the audio embeddings correspond to the face crops.

In some implementations, the face crops used for the MMA processing may include a sequence of face crops and associated data. With a longer sequence of face crops corresponding to between 0.5 seconds and 3 seconds, for example, the MMA audio embeddings can be matched more reliably by the MMA processing to the face crop sequences. Essentially the MMA processing 338 can match the audio by way of the audio embeddings to the mouth positions in the sequence of face crops. Each of the face crop sequences is processed against the embeddings for the audio segments and a match is determined. After matching the face crop sequences to the audio segments, the MMA processing 338 can provide an indication to the MMA processing 376 of the identity of the person speaking, for example, by providing the face id, name, or user ID (if known) of the person speaking. The MMA processing 376 can determine, using the additional video data (i.e., metadata), the face position corresponding to the person identified as speaking. If the face position indicates that the person was facing the electronic device 110, 115, and/or 120, then the MMA processing 376 can determine that the person speaking intended to engage a user interaction with the device. If the person was facing away in the face crops, for example, facing another person, then the face position indicates as such and the MMA processing 376 can determine that the person was not intending to interact with the electronic device 110, 115, and/or 120.

In some implementations, the perception system can run while the user is interacting with the device in another application and provide information to the application about how the interaction might have changed. For example, if the user is engaged in a video call and moves closer to the device, then the perception system can determine that the user moved closer to the device and notify that the user moved closer to the device. As a result, the application conducting the video call can adjust the camera or display a message to the user to recommend backing up or the like. In another example, if a user is engaged in a video call and moves out of the frame and a different person comes into the frame, the perception system can recognize the new person (or at least that the person changed) and can update a display to indicate an identification of the new person or remove an identification indicator of the person who left the frame.

Following the processing of the video frame data, such as the frame crop data, the perception orchestrator 365 can instruct the perception system 325 to clear memory caches. In a similar manner the perception orchestrator 365 can instruct the perception system 325 to clear cache for the frame sequence data used by the MMA processing 338. In some implementations, the audio buffer can also be cleared, while in other implementations, the audio buffer loops so that it is constantly overwritten by the audio capture process 314.

In some implementations, the identity information and time stamp data for the audio information may be sent to another application. For example, the device may have an application and system client running thereon that responds to key words. The identity information and time stamp information for the audio segment can be sent to the client. The client can use the time stamp information to retrieve audio input data from the audio capture memory based on the time stamp and preform analysis on the audio input data to determine the content of the audio input data. Then the client can respond according to the content of the audio input data and customize a response based on the identity. For example, if a user faced the device and said, “play a song,” then the perception system could recognize that the user was attempting to interact with the device and identify the user. This information can be provided to the client and the client can obtain the content from the audio input data to “play a song,” and select a song based on a user preference of the identified user.

When the audio input data is made available to a client application, an indicator on the device may be activated to let the user know that data is leaving the exclave environment 320 and is available to one or more applications. The indicator may be a small LED, a sound, such as a chime, a vibration, an indicator on a display screen of the device, and so forth. In this manner, people in the vicinity of the device can be notified that the microphone is actively providing data from the surroundings to an application outside of the exclave environment 320.

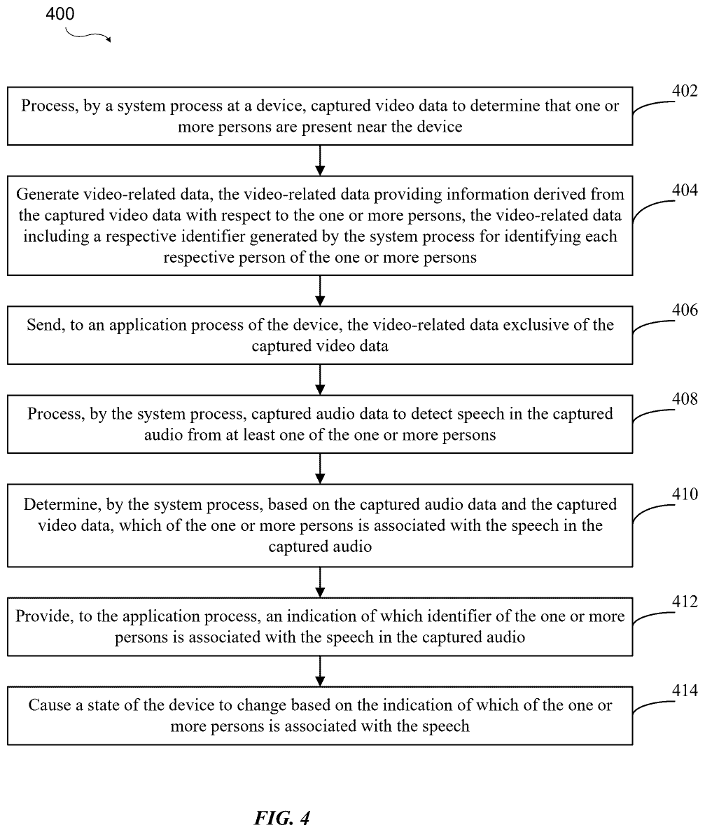

FIG. 4 illustrates a flow diagram of an example process 400 for determining an intended user interaction, in accordance with some implementations. One or more blocks (or operations) of the process flow diagram of FIG. 4 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 402, a system process at a device may process captured video data to determine that one or more persons are present near the device. For example, a process can be used to capture the video data and perform some analysis on the video data to determine that one or more persons are in a frame of the video data.

At block 404, video-related data can be generated, where the video-related data provides information derived from the captured video data with respect to the one or more persons, the video-related data may include a respective identifier generated by the system process for identifying each respective person of the one or more persons. For example, the captured frame can be analyzed to determine where each person is located in the frame and may take cropped images of their faces. Other features of the one or more persons, such as face pose, body pose, hand position, arm position, etc. can be observed by the system process for the captured frame.

At block 406, the video-related data can be sent to an application process of the device, where the sent video-related data is sent exclusive of the captured video data. In other words, the video-related data does not contain the pixel or raw image data for the frame, but only the information about the frame image and information about the contents derived therefrom, as described above.

At block 408, the system process may process captured audio data to detect speech in the captured audio from at least one of the one or more persons. For example, the system may receive audio data from one or more microphones and may process a segment of the captured audio data to determine if speech is in the captured audio data. The speech, for example, may be provided by the one or more persons and so a process can be undertaken to determine if the speech is provided by one of the one or more persons and, if so, which one.

At block 410, the system process may include determining, based on the captured audio data and the captured video data, which of the one or more persons is associated with the speech in the captured audio. For example, a process can be undertaken, such as described above, to match the audio to the captured video data to determine which of the one or more persons is speaking to provide the captured audio data. This determination can be used in conjunction with data from the captured video data to determine if an interaction of the user to the device was intended. For example, if the person of the one or more persons who is talking is facing the device when they were talking, then an interaction may be determined to have been intended by the user with the device. On the other hand, if the person of the one or more persons who is talking is facing another one of the persons or away from the device, then it may be determined that an interaction was not intended.

At block 412, the system process, may provide to an application process, an indication of which of the one or more persons is associated with the speech in the captured video data and the captured audio data. The indication may include, for example, a name or user ID, if available from a previous process utilized to find the identity information for the video capture information, such as described above with respect to the identification processing 374. Along with the indication of the person the system process may also include a timestamp of when the interaction began. The application process can use the time stamp to access the audio buffer associated with the audio segment, and perform additional analysis on it, such as determining the content of the speech. The application process can then use the identifying information and the audio information to provide a customized response to the user.

At block 414, a state of the device is caused to be changed based on the indication of which of the one or more persons is associated with the speech. For example, an indicator can be provided at the device to let the user know that audio data is being shared with an application outside of the exclave environment. The indicator can be a light that is lit, can be a message on a screen of the device, a sound played by the device, a vibration, or a combination thereof.

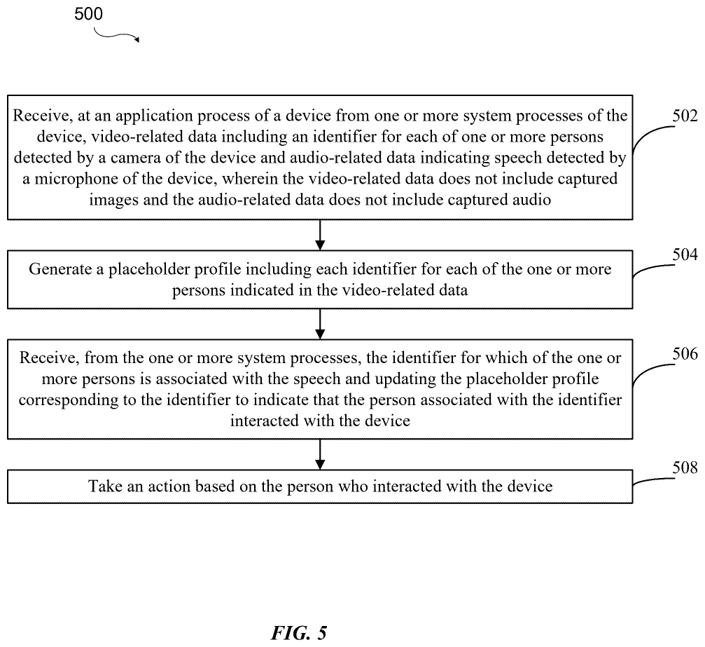

FIG. 5 illustrates a flow diagram of an example process 500 for determining at an application process that a user interacts with a device and determining an identifier of the user that interacts with the device, in accordance with some implementations. One or more blocks (or operations) of the process flow diagram of FIG. 5 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 502, an application process of a device may receive from one or more system processes of the device, video-related data including an identifier for each of one or more persons detected by a camera of the device and audio-related data indicating speech detected by a microphone of the device, where the video-related data does not include captured images and the audio-related data does not include captured audio. For example, the application process can receive information about a captured frame from the camera including information regarding each face of a number of faces in the frame, such as a position of each face in the frame and an orientation of each face in the frame. An identifier for each of these persons may be provided by the system process to the application process which can receive the identifiers.

At block 504, the application process may generate a placeholder profile including each identifier for each of the one or more persons indicated in the video-related data. For example, the application process may generate a placeholder profile that includes each identifier as well as the video-related information received for the one or more persons, such as the face, hand, leg, arm, and/or body position, the location of the face in the frame, and so forth.

At block 506, the application process may receive, from the one or more system processes, the identifier for which of the one or more persons is associated with the speech and update the placeholder profile corresponding to the speech identifier to indicate that the person associated with the speech identifier interacted with the device. For example, an identifier may correspond to a name or user ID of the person who attempted to interact with the device. Because the identity of the person speaking may match the identity of a person whose face is turned toward the device, a user interaction may be determined to have occurred.

At block 508, an action may be taken based on the person who interacted with the device. For example, a user preference may be set in the device to take a particular action when that user interacts with the device. In another example, the application process can call another application process and pass the identity information to that application process. That application process can then provide a customized response based on the identity information of the user.

As described above, one aspect of the present technology is the gathering and use of data available from specific and legitimate sources for providing automatic adaptive noise cancellation for electronic devices. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for operating an electronic device to provide automatic adaptive noise cancellation for electronic devices. Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device to provide automatic adaptive noise cancellation for electronic devices, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 6 illustrates an electronic system 600 with which one or more implementations of the subject technology may be implemented. The electronic system 600 can be, and/or can be a part of, one or more of the electronic devices 110, 115, and/or 120. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
processing, by a system process at a device, captured video data to determine that one or more persons are present near the device;
generating video-related data, the video-related data providing information derived from the captured video data with respect to the one or more persons, the video-related data including a respective identifier generated by the system process for identifying each respective person of the one or more persons;
sending, to an application process of the device, the video-related data exclusive of the captured video data;
processing, by the system process, captured audio data to detect speech in the captured audio data from at least one of the one or more persons;
determining, by the system process, based on the captured audio data and the captured video data, which of the one or more persons is associated with the speech in the captured audio data;
providing, to the application process, an indication of which of the one or more persons is associated with the speech in the captured audio data; and
causing a state of the device to change based on the indication of which of the one or more persons is associated with the speech.

2. The method of claim 1, further comprising:
processing, by the system process, the captured video data to determine at least one face in the captured video data and extract a crop of each face in the captured video data.

3. The method of claim 2, wherein the video-related data comprises frame location information for each face in the captured video data corresponding to each crop.

4. The method of claim 2, wherein determining which of the one or more persons is associated with the speech in the captured audio comprises:
interrelating a sequence of the crops to the captured audio data to determine which of the crops is associated with the captured audio data.

5. The method of claim 2, further comprising:
storing the crops in a buffer; and
purging the buffer after determining which of the one or more persons is associated with the speech.

6. The method of claim 1, wherein the captured audio data includes spatial audio information, and wherein the captured audio data includes time stamp information, the method further comprising:
providing, to the application process, the spatial audio information for the captured audio data; and
providing, to the application process, the time stamp information for the captured audio data.

7. The method of claim 1, further comprising:
providing, to the application process, identity (ID) information for at least one of the one or more persons.

8. The method of claim 7, further comprising:
obtaining a first embedding based on the captured video data for the at least one of the one or more persons present near the device;
analyzing the first embedding to determine the ID information and a confidence associated with the ID information for the at least one of the one or more persons; and
providing, to the application process, the confidence in addition to providing the ID information.

9. The method of claim 1, further comprising:
obtaining a second embedding based on the captured audio data for the detected speech;
analyzing, by the system process, the second embedding to determine the ID information for the at least one of the one or more persons present near the device, the ID information associated with the detected speech; and
providing, to the application process, the ID information.

10. The method of claim 1, wherein causing the state of the device to change includes providing an indication that the captured audio data is being made available to one or more application processes.

11. The method of claim 1, wherein the video-related data includes an indication that additional video-related data is available at the system process, further comprising:
in response to a request from the application process, providing the additional video-related data to the application process.

12. A device comprising:
a memory; and
one or more processors configured to:
receive, at an application process of a device from one or more system processes of the device, video-related data including an identifier for each of one or more persons detected by a camera of the device and audio-related data indicating speech detected by a microphone of the device, wherein the video-related data does not include captured images and the audio-related data does not include captured audio;
generate a placeholder profile including each identifier for each of the one or more persons indicated in the video-related data;
receive, from the one or more system processes, the identifier for which of the one or more persons is associated with the speech and updating the placeholder profile corresponding to the identifier to indicate that the person associated with the identifier interacted with the device; and
perform an action based on the person who interacted with the device.

13. The device of claim 12, wherein the one or more processors are further configured to:
receive, from the one or more system processes, first ID information for the placeholder profiles; and
associate the first ID information with the placeholder profiles, wherein the first ID information corresponds to identifying information for the one or more persons indicated in the video-related data.

14. The device of claim 13, wherein the one or more processors are further configured to:
receive, from the one or more system processes, second ID information corresponding to the audio-related data, wherein the second ID information corresponds to identifying information for the detected speech.

15. The device of claim 14, wherein the action comprises: changing a state of the device or sending a notification to another application process based on at least one of the first ID information, the second ID information, or the identifier for which of the one or more persons is associated with the speech.

16. The device of claim 15, wherein changing the state of the device comprises:
changing a display of the device to display content customized based on the first ID information, the second ID information, or the identifier for which of the one or more persons is associated with the speech.

17. The device of claim 12, wherein the video-related data is based on captured image data held exclusive of the application process by the one or more system processes, wherein the audio-related data is based on captured audio data held exclusive of the application process by the one or more system processes, wherein the video-related data includes frame location information for each of one or more persons, and wherein the video-related data includes face pose information or hand position information.

18. The method of claim 12, wherein the identifier for which of the one or more persons is associated with the speech is based at least in part on a determination at the one or more system processes that a portion of captured images from the camera of the device matches a portion of captured audio from the microphone of the device.

19. A system comprising:
a device including a camera and display;
a system process of the device configured to:
process captured video data to determine that a position of a person in the captured video data has changed relative to the device,
generate video-related data, the video-related data providing information about the position of the person, and
send, to an application process of the device, the video-related data; and
the application process of the device configured to:
update the display based on the video-related data indicating a change of the position of the person.

20. The system of claim 19, wherein the video-related data indicates that the position of the person in the captured video data is closer to the device or more directed to the device than a previous position.
